(19) United States
(12) Patent Application Publication
(10) Pub. No.: US 2007/0219655 A1
(43) Pub. Date: Sep. 20, 2007

(54) External remote with display accessory

(76) Inventors: Craig S. Erickson, Stevenson Ranch, CA (US); Yung Wai Lam William, Heng Fa Chuen (HK)

Correspondence Address: RICHARD B. CATES, 2629 MANHATTAN AVE, PMB-273, HERMOSA BEACH, CA, 90254, US

(21) Appl. No.: 11/375,729

(22) Filed: Mar. 15, 2006

(51) Int. Cl. G06F 17/00

(52) U.S. Cl. 700/94

(57) ABSTRACT

The invention is a system, apparatus, and method for controlling and enjoying playback from a portable playback device, such as an MP3 player. The apparatus is a remote control, with a first portion having a dock configured to be attached to the portable playback device, and a second portion having a display and controls configured to control output from the portable playback device. The first portion and second portion can be separate elements, and can be connected by a flexible line. The apparatus can be easily worn by a user.

### FIELD OF THE INVENTION

The present invention relates to the control of operations of a portable playback device, and more particularly, to an external remote control accessory that can be used together with a portable playback device, such as a digital audio player or a digital audio device (e.g., MP3 player) or portable media player device (PMP) to allow for controlling and displaying feedback and detailed track and list information from such devices.

### BACKGROUND

A number of portable playback devices are known in the art, including digital audio players, digital audio devices, and digital video and music players for playing back compressed music/audio/video files. By far the most popular compressed music/audio/video formats today are MP3 & MP4, and the IPOD® player marketed by Apple Computer is one well-known example of such a player. (APPLE® and IPOD® are registered trademarks of Apple Computer, Inc., a California corporation.)

It is often desirable to play digital video (e.g., a movie) and/or animated graphics as well as music while these devices reside in their carrying cases. This is not always convenient as these devices have their controls and displays on their faces and are typically covered or not readily visible while in these cases. Additionally, even with their controls uncovered, the controls for these devices are not always conveniently configured for operation by a user, and their LCD displays can be relatively small.

Therefore, it is desirable to provide an external wired remote accessory capable of working with off-the-shelf portable MP3 players and/or other digital audio/video players to provide feedback display while these devices reside in their cases, allowing the user the ease of use but not requiring the devices to be removed from their cases when controlling them.

### SUMMARY

The invention is a system and apparatus for playing selected audio and/or video recordings, including control and display devices for such playback. In an embodiment of the present invention, a portable digital music/video player wired remote control accessory with its own display for use with a portable digital audio and/or video player is provided. The portable digital music/video player accessory includes a display screen for displaying control status and track information thereon, and a processing core used for controlling this display on the display screen. The wired remote accessory control will communicate with the portable digital music/video player, and the processing core will display the control feedback information on its display. The portable digital music/video player wired remote accessory also includes a serial interface port for interfacing with a corresponding serial port of the portable digital audio and/or video player to receive the control data therefrom. The portable digital audio/video player accessory also includes a power source for supplying power to the display screen and the processing core.

The portable digital audio and/or video player may be a portable MP3 and/or MP4 player, such as an IPOD® player from Apple Computer, Inc.; an M25™ or M100™ digital audio player from Motorola; a Creative Zen™ portable media center from Creative Technologies, Inc.; or a FlashTrax® portable media player (capable of playing video, audio, and data) from SmartDisk Corporation.

In a further embodiment of the present invention, a method of another communication link using an OTG USB port (“On The Go” type USB port), instead of or in addition to a serial port, is provided.

Other objects, features, and advantages of the present invention will become apparent from a consideration of the following detailed description.

### BRIEF DESCRIPTION OF THE DRAWINGS

FIG. 1 is a block diagram of an external remote control/display accessory according to an embodiment of the present invention;

FIG. 2 is a block diagram of the external remote with display accessory of FIG. 1 being used with a portable audio/video player via a serial port;

FIG. 3 is a block diagram of the external remote with display accessory of FIG. 1 being used with a portable audio/video player via a serial port and USB port;

FIG. 4 is a front view of an external remote with display accessory according to an embodiment of the present invention; and

FIG. 5 is a side view of the accessory of FIG. 4.

### DETAILED DESCRIPTION

In embodiments of the present invention, an external remote control/display accessory includes one or more controls for controlling output from a portable digital audio and/or video player, and a display screen for displaying various user control information and track information, lists and status. The display screen may include a liquid crystal display (LCD) or any other suitable display device known to those skilled in the art, or a suitable display device that will be developed in the future. The external control/display accessory, therefore, allows the user to control the portable digital audio and/or video player and, where applicable, view video output without having to remove the player from the carrying case.

Depending on the particular embodiment, the external remote control/display accessory may have its own power source, such as a standard or rechargeable battery. By way of example, the power to the external control/display accessory can be provided by an internal lithium ion rechargeable battery. In addition, the external control/display accessory includes electronic circuitry (e.g., on an integrated circuit chip) and a processing core for controlling the display as well as for interfacing with the portable digital audio or video player (and/or a hard drive thereof).

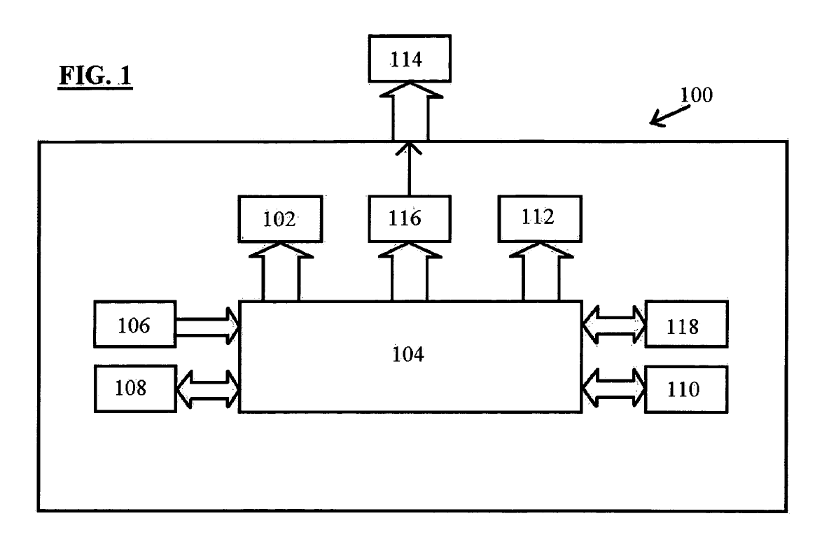

As can be seen in FIG. 1, an external control/display accessory 100 includes a display 102, a processing core 104, and a power source 106. The external control/display accessory 100 also includes one or more communication ports, which in the embodiment depicted in FIG. 1 includes a serial port 108. As an alternative to the serial port 108, or in addition thereto (as depicted in FIG. 1), the external control/display accessory 100 may include a universal serial bus (USB) port 110, such as an OTG USB port. A parallel port (not shown) may also be included as a communication port, in lieu of or in addition to the serial port 108 and/or USB port 110. The selection of communication port(s) depends on the particular application, including the particular audio and/or video player(s) with which the external control/display accessory 100 is intended to interact.

The display 102 may be black & white, monochrome, or color, and may be an LCD or any other suitable display device/screen. By way of example, the display 102 may be 1.0 inches to 1.8 inches in size, and may have a resolution of 112×80 pixels, 80×50 pixels, or the like.

The processing core 104 is a control/communication device that can include any suitable integrated circuit chip, such as an SPL130A chip available from Sunplus Technology. The processing core 104 can include the protocols for communicating with portable audio and/or video devices to control and retrieve information from these devices. The processing core 104 can also include a display driver to control display of the video on the display 102. In addition, the processing core 104 may include a sound amplifier/driver to generate and control audio output status. A speaker or speakers 112 may be included as an integral part of the external control/display accessory 100. As an alternative or in addition to any integral speaker(s) 112, a headset 114 or other external speaker(s) may be connected to the external control/display accessory via a headphone jack 116.

In the embodiment of FIG. 1, the external control/display accessory 100 includes a control 118, through which a user can control various functions of the audio and/or video player. The control 118 may be configured to permit the user to control such functions as volume (up and/or down), track selection, play/pause, preview track, on/off, etc. The control 118 may include a keyboard having several individual keys for specific function control. For example, the keyboard may have 5 keys with the following functions: volume up, volume down, next track, preview track, play/pause. The keyboard may be formed of standard push buttons, a touch-sensitive assembly/screen, etc.

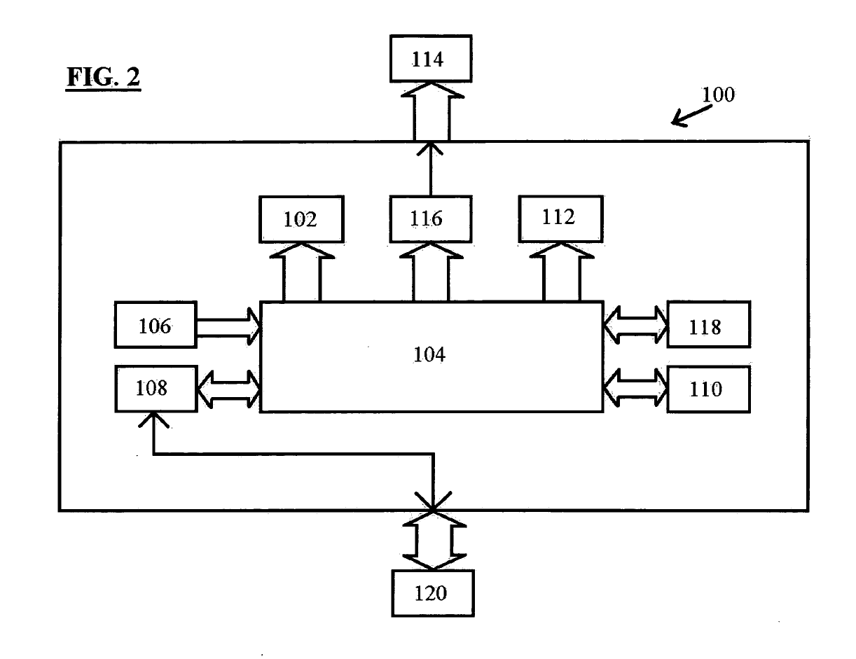

As shown in FIG. 2, the external remote with display accessory 100 can be used together with a portable audio and/or video player 120. The serial port 108 or the OTG USB port 110 is used to communicate with the portable audio and/or video player 120 operating system to control the operation of the portable audio and/or video player 120 and to obtain feedback as requested for display to the user.

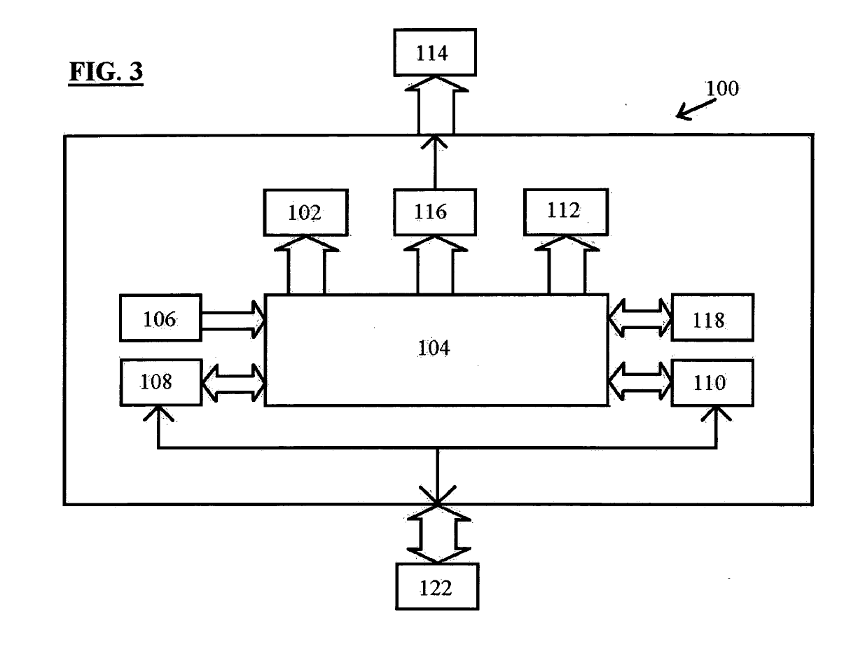

The external remote is applicable to various portable audio/video players, and not just portable audio and/or video players that use a serial port. As shown in FIG. 3, the external remote with display accessory 100 can be used together with any suitable portable audio/video device 122. The serial port 108 and/or the OTG USB port 110, and/or other suitable communication port, is used to communicate with the operating system residing in the portable audio/video device 122 and to control and receive user feedback.

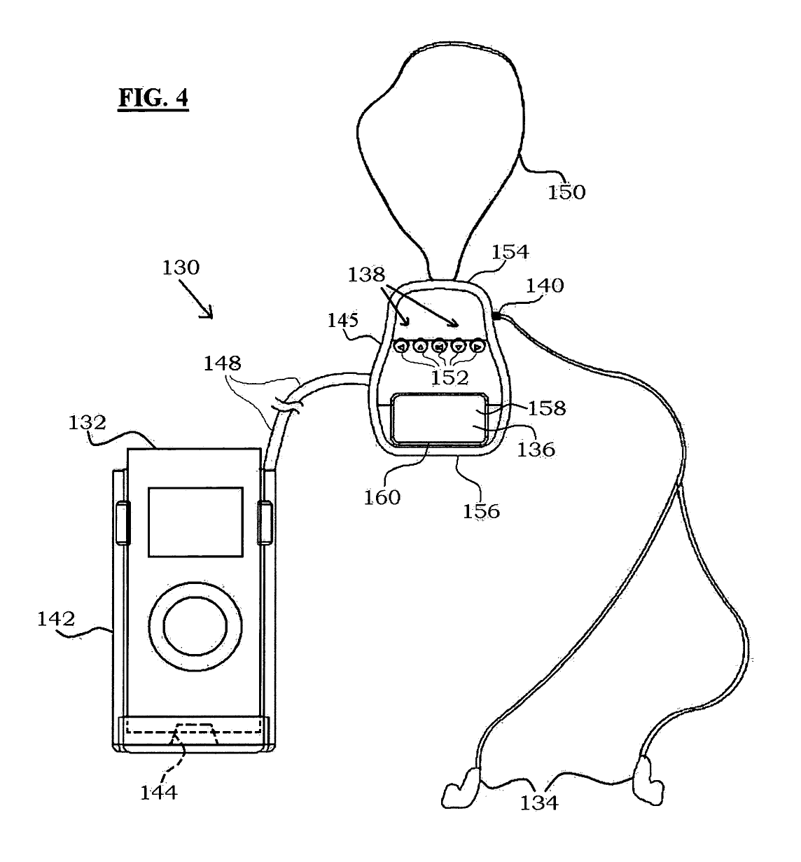

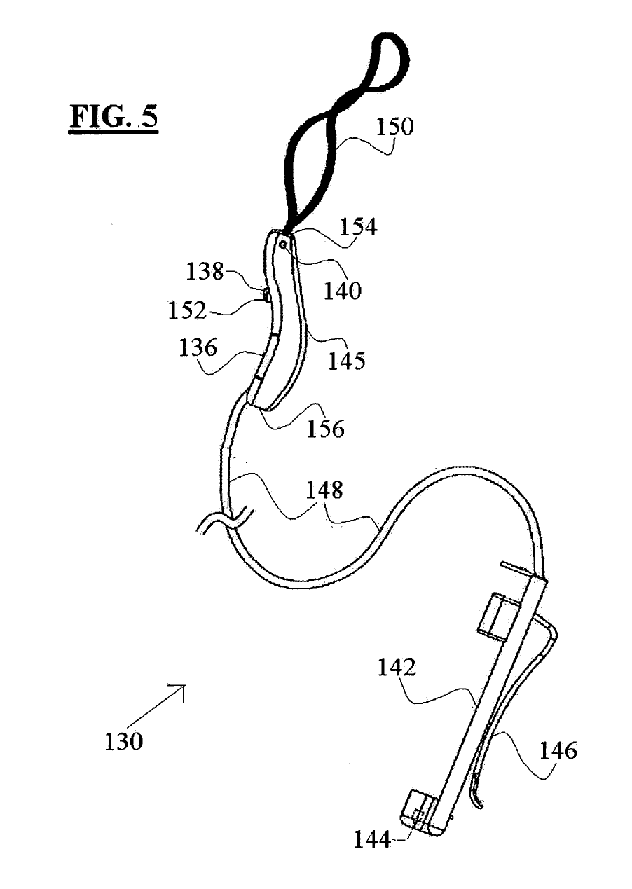

FIG. 4 depicts an embodiment of an external remote control/display accessory 130 with a portable audio/video player 132 and headphones 134, while FIG. 5 depicts the external remote control/display accessory of FIG. 4 in side view and without the portable audio/video player and headphones 134. The accessory 130 includes a display 136, control 138, headphone jack 140, and communication dock 142 with one or more communication ports 144. The communication dock 142 is configured to receive and securely hold the portable audio/video player 132. Depending on the particular embodiment, the communication dock 142 can be configured to receive and/or hold the portable audio/video player without requiring the player's removal from its protective case (if present). In the particular embodiment of FIGS. 4 and 5, the display 136, control 138, and headphone jack are located on the accessory main body 145.

The communication dock 142 of FIGS. 4 and 5 includes an attachment device in the form of a clip 146 which permits the user to removably attach the communication dock 142 to the user's clothing at a desired location, such as at a belt or waistline of the user. Other attachment devices are also within the scope of the invention, such as hook-and-loop fasteners, buckles, wrist bands, stretch bands and/or cases, silicon cases, etc. The communication dock 142 is connected to the main body 145 of the external remote control/display accessory 130 via a cord 148. The cord 148 may have sufficient length and flexibility to permit the user to attach the communication dock 142 securely to a remote location, such as the user's belt, while still allowing the user to hang the main body 145 of the portable audio remote control/display accessory 130 about the user's neck via the neck loop 150. In one embodiment of the invention, the cord 148 has a length of between 1 and 3 feet, with a length of about 2 feet appropriate for some applications. The length is preferably long enough to permit ease of use, but short enough that it doesn't present an unwieldy and/or awkward length of line that may interfere with the user's enjoyment of the device.

The control 138 includes a plurality of buttons 152, including individual control buttons for volume up, volume down, play/pause, skip back, and skip forward. Note that other individual control buttons are also within the scope of the invention. In the embodiment of FIGS. 4 and 5, the neck loop 150 is configured to permit the main body 145 of the remote control/display accessory 130 to be hung around the neck of a user, with the neck loop 150 attached to the accessory main body 145 at a proximal end 154 of the accessory main body 145.

In the embodiment of FIG. 4, the display 136 is positioned near a distal end 156 of the accessory main body 145, with the top 160 of the display image 158 positioned closer to the main body distal end 156 so that the display image 158 is in the “right-side up” configuration when the accessory main body 145 is viewed with the main body distal end 156 positioned, in the viewer's field of view, above the main body proximal end 154. When a user is wearing the accessory main body 145 around his or her neck via the neck loop 150, the user can look directly down onto the accessory main body 145 and view the display image in a “right-side up” configuration. The user can also hold the accessory main body 145 in a fixed position in front of the user's face (with the neck loop 150 hanging below the accessory main body 145), so that the accessory main body 145 is in a more comfortable viewing position. In either such case, the accessory distal end 156 will appear higher in the user's field of view than the proximal end 154, and the display image 158 will appear in the “right-side up” configuration to the user. In a further embodiment of the invention, the display image could be positioned with the top 160 of the display image 158 positioned closer to the main body proximal end 154, which could allow a user to easily view the display in the right-side up configuration when the main body 145 were hanging from a hook or around the neck of someone other than the viewer. The accessory 130 could also be configured so that the display image could be selectively inverted and/or rotated as desired for a desired viewing situation.

While the invention has been described with reference to particular embodiments, it will be understood that various changes and additional variations may be made and equivalents may be substituted for elements thereof without departing from the scope of the invention or the inventive concept thereof. In addition, many modifications may be made to adapt a particular situation or device to the teachings of the invention without departing from the essential scope thereof. Therefore, it is intended that the invention not be limited to the particular embodiments disclosed herein, but that the invention will include all embodiments falling within the scope of the appended claims.

What is claimed is:

1. An apparatus for controlling output from a portable playback device, comprising:
a first portion;
a second portion;
a portable power supply;
a display;
one or more control elements configured to control one or more operations of a portable playback device, wherein the control elements are positioned on or in the second portion;
a dock configured to connect to a portable playback device, wherein the dock is positioned on or in the first portion;
wherein the first portion and the second portion are not rigidly connected together and are spaced apart.

2. The apparatus of claim 1, wherein the display is positioned on or in the second portion.

3. The apparatus of claim 1, wherein the one or more control elements comprise a plurality of control buttons.

4. The apparatus of claim 1, further comprising:
a flexible line passing between the first portion and the second portion.

5. The apparatus of claim 4, wherein the flexible line is a communication line.

6. The apparatus of claim 4, wherein the flexible line has a length of at least one foot.

7. The apparatus of claim 6, wherein the flexible line has a length no greater than 3 feet.

8. The apparatus of claim 1, further comprising:
a headphone jack.

9. The apparatus of claim 1, further comprising:
a neck loop configured to be placed about the neck of a user, wherein the neck loop is secured to the second portion.

10. The apparatus of claim 3, wherein the second portion comprises a proximal end and a distal end, the display is configured so that it is viewed in a right-side up configuration when the second portion distal end is higher in the user's field of view than is the second portion proximal end, and wherein the apparatus further comprises:
a neck loop configured to be placed about the neck of a user, wherein the neck loop is secured to the second portion at or adjacent the proximal end.

11. The apparatus of claim 1, further comprising:
a clothing connector configured to be secured to clothing, wherein the clothing connector is positioned on the first portion.

12. The apparatus of claim 11, wherein the clothing connector comprises a belt clip.

13. A method for controlling operation of a portable playback device, comprising:
providing a portable playback device;
providing a portable remote apparatus comprising a power supply, a display, a first portion, and a second portion, wherein the first portion comprises a communication dock, and the second portion comprises one or more control elements;
connecting the portable playback device to the first portion via the communication dock;
securing the first portion to a user at a first location on the user's person;
securing the second portion to the user at a second location on the user's person, wherein the first location and the second location comprise two separate locations;
controlling operations of the portable playback device by selectively activating the one or more control elements on the second portion; and
viewing the display.

14. The method of claim 13, wherein securing the first portion to a user at a first location on the user's person occurs prior to connecting the portable playback device to the first portion via the communication dock.

15. The method of claim 13, wherein the second portion comprises a neck loop configured for placement about the neck of the user, and wherein securing the second portion to a second location on the user's person comprises placing the neck loop about the neck of the user.

16. The method of claim 13, wherein the first portion comprises a clothing connector configured to be secured to clothing, and wherein securing the first portion to a first location on the user's person comprises securing the clothing connector to an article of clothing worn by the user.

17. The method of claim 13, wherein the first portion comprises a wrist band, and wherein securing the first portion to a first location on the user's person comprises placing the wrist band about a wrist of a user.

18. A system for playing back recordings, comprising:
a first portion;
a second portion;
a portable power source;
a portable playback device positioned on or in the first portion;
a display positioned on or in the second portion;
one or more control elements positioned on or in the second portion;
wherein the first portion and second portion are not rigidly connected together and are spaced apart.

19. The system of claim 18, further comprising:
a flexible line passing between the first portion and the second portion, wherein the flexible line is a communication line having a length greater than one foot.

20. The system of claim 18, wherein the portable playback device is connected to the first portion via a communication dock.
